(19) United States
(12) Patent Application Publication
(10) Pub. No.: US 2005/0132849 A1
(43) Pub. Date: Jun. 23, 2005

(54) Driver wrench

(76) Inventor: Richard J. Macor, Hunterdon County, NJ (US)

Correspondence Address: Richard J. Macor;Proprietary Technologies, Inc., 26 Alpaugh Drive, Asbury, NJ, 08802-1213, US

(21) Appl. No.: 10/844,727

(22) Filed: May 13, 2004

Related U.S. Application Data
(63) Continuation-in-part of application No. 29/203,320, filed on Apr. 12, 2004.
Application No. 29/203,320 is a continuation-in-part of application No. 29/196,022, filed on Dec. 19, 2003.

(51) Int. Cl. B25B 13/00

(52) U.S. Cl. 81/125.1

(57) ABSTRACT

A double-ended wrench is described comprising a wrench head positioned at one end thereof having a first orifice formed for engagement with various fasteners. The first orifice has an across-width dimension and a depth dimension and an imaginary central axis of wrench rotation. The across-width dimension is generally greater than the depth dimension. There is a first handle portion connected to the wrench head. The first handle portion is elongated in a predetermined longitudinal direction, and has a cross-sectional shape and a defined minimum cross-sectional thickness when viewed in a cross-sectional plane perpendicular to the longitudinal direction. The cross-sectional shape of the first handle portion is elongated in a direction substantially perpendicular to the axis of wrench rotation of the first orifice. And, there is a second handle portion connected at the other end of the wrench. The second handle portion is elongated in the predetermined longitudinal direction, and has a defined minimum cross-sectional thickness substantially greater than the defined minimum cross-sectional thickness of the first handle portion. The second handle portion further has a distal end with a second orifice formed therein. The second orifice is formed for engagement with various fasteners and has an imaginary axis of wrench rotation that is substantially aligned with the predetermined longitudinal direction. In some preferred embodiments of the present invention, the second handle portion is fixedly connected to the wrench.

### REFERENCES TO RELATED APPLICATIONS

This application relates to and is a Continuation-In-Part of U.S. patent application Ser. No. 29/203,320 entitled ERGONOMIC DRIVER WRENCH filed on Apr. 12, 2004 by the inventor herein; which is a Continuation-In-Part of U.S. patent application Ser. No. 29/196,022 entitled DOUBLE-HEADED WRENCH filed on Dec. 19, 2003 by the inventor herein.

### FIELD OF THE INVENTION

The present invention relates to hand tools, particularly wrenches and most particularly double-ended wrenches.

### BACKGROUND OF THE INVENTION

Hand operated double-ended wrenches have been around for many years and they are typically structured having an elongated, flat shaped handle with a wrench head at each end for turning various fasteners. Typical variations include combination, double box, double open-end, flex-head type and the like. The elongated flat handle of a typical prior art double-ended wrench provides only a thin surface area for the application of force by a user to turn and operate the wrench. This thin surface area creates user discomfort and fatigue while limiting torque and continuous-use capabilities during high torque operations. In addition, typical prior art double-ended wrenches are not structured for low torque operations during which a fastener may be “driven” quickly using a wrist operation similar to that used with a screwdriver. The only prior art double-ended wrench known to applicant which provides possible wrist operated “driving” capabilities is a wrench commercially known as a “Saltus” wrench, and/or flex-head type wrenches. This wrench, however, with its short pivoting socket at one end thereof contributes to the aforementioned user discomfort and fatigue during high torque operations. Accordingly, applicant believes there is real need to develop an improved double-ended wrench, one which provides improved user comfort and ergonomics during high torque operations, and, improved user control and speed during low torque operations especially in tight spaces and limited-access environments.

### SUMMARY OF THE INVENTION

The present invention involves a double-ended wrench comprising a wrench head positioned at one end thereof having a first orifice formed for engagement with various fasteners. The first orifice has an across-width dimension and a depth dimension and an imaginary central axis of wrench rotation. The across-width dimension is generally greater than the depth dimension. There is a first handle portion connected to the wrench head. The first handle portion is elongated in a predetermined longitudinal direction, and has a cross-sectional shape and a defined minimum cross-sectional thickness when viewed in a cross-sectional plane perpendicular to the longitudinal direction. The cross-sectional shape of the first handle portion is elongated in a direction substantially perpendicular to the axis of wrench rotation of the first orifice. And, there is a second handle portion connected at the other end of the wrench. The second handle portion is elongated in the predetermined longitudinal direction, and has a defined minimum cross-sectional thickness substantially greater than the defined minimum cross-sectional thickness of the first handle portion. The second handle portion further has a distal end with a second orifice formed therein. The second orifice is formed for engagement with various fasteners and has an imaginary axis of wrench rotation that is substantially aligned with the predetermined longitudinal direction. In some preferred embodiments of the present invention, the second handle portion is fixedly connected to the wrench.

Applicant believes there is real need to develop an improved double-ended wrench, one which provides improved user comfort and ergonomics during high torque operations, and, improved user control and speed during low torque operations so that a fastener may be “driven” quickly using a wrist operation similar to that Used with a screwdriver.

Accordingly, it is an important objective of the present invention described herein that it be structured for high torque operations with a relatively large, comfortable and ergonomic handle portion for the application of force by a user during high torque operations.

It is another important objective of the present invention that it be structured for low torque operations so that a fastener may be “driven” on or off quickly using a wrist operation similar to that used with a screwdriver.

It is another important objective of the present invention that it provides ergonomic user control and speed, especially in confined spaces and limited-access environments.

It is another objective of the present invention that it be durable and strong.

It is another objective of the present invention that it be commercially viable, simple in design, and cost efficient to manufacture.

### BRIEF DESCRIPTION OF THE DRAWINGS

FIG. 1 shows a front elevation view of a present invention driver wrench; and,

FIG. 2 shows a rear elevation view of the present invention driver wrench shown in FIG. 1; and,

FIG. 3 shows a left side elevation view of the present invention driver wrench shown in FIGS. 1 and 2; and,

FIG. 4 is a top plan view of a present invention driver wrench shown in FIGS. 1, 2 and 3; and,

FIG. 5 shows a bottom plan view of the present invention driver wrench shown in FIGS. 1, 2, 3 and 4; and,

FIG. 6 shows a front cross-sectional view of only the first handle portion of the present invention driver wrench shown in the previous Figures; and,

FIG. 7 shows a left side, cross-sectional view of another embodiment of a present invention driver wrench; and,

FIG. 8 shows a top plan view of another embodiment of a present invention driver wrench; and,

FIG. 9 shows a left side elevation view of the present invention driver wrench shown in FIG. 8; and,

FIG. 10 shows a top plan view of another embodiment of a present invention driver wrench; and,

FIG. 11 shows a left side elevation view of the present invention driver wrench shown in FIG. 10.

### DETAILED DESCRIPTION OF THE DRAWINGS

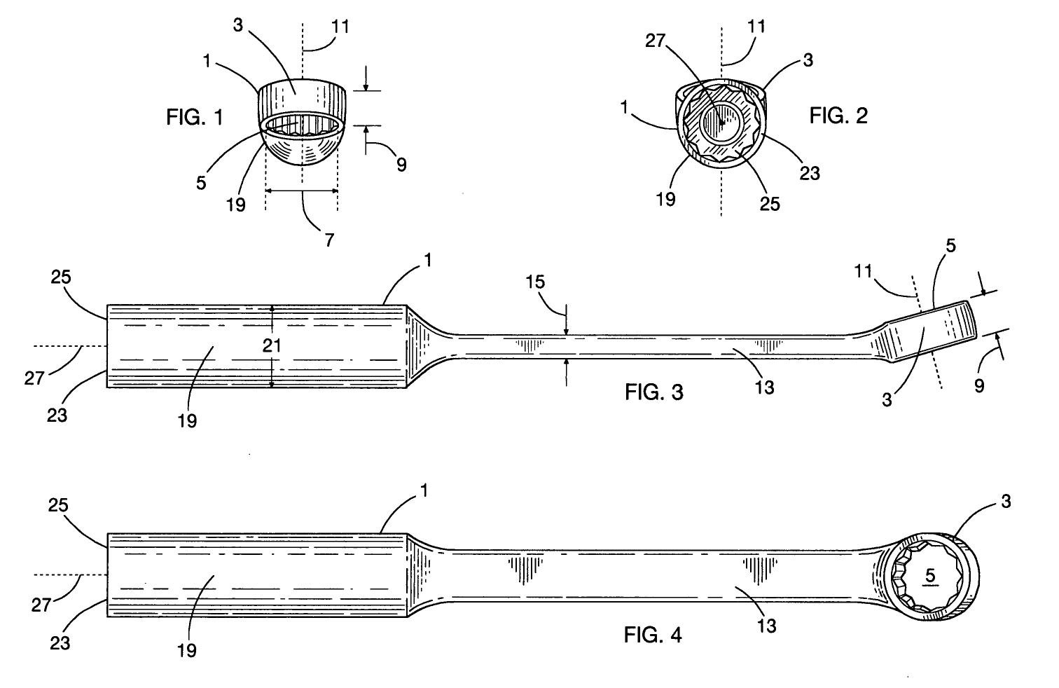

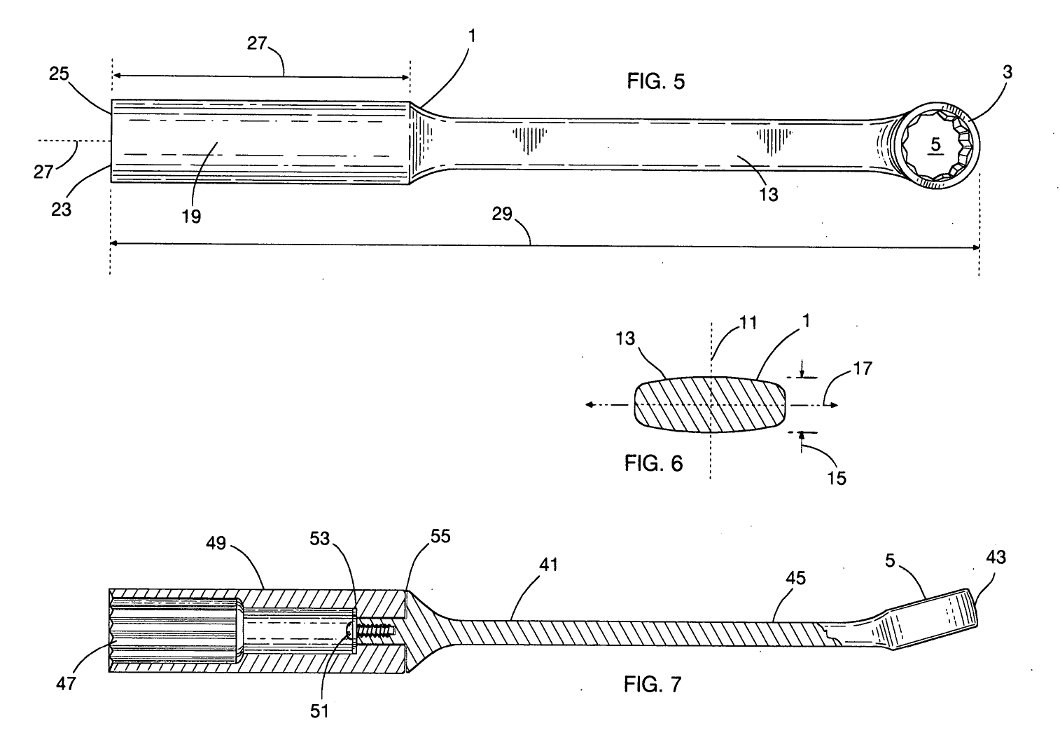

Referring now to the drawings which are for the purpose of illustrating preferred embodiments of the present invention and not for the purpose of limiting same, FIGS. 1, 2, 3, 4, 5 and 6 all show different views of the same present invention driver wrench. Wrench 1 comprises a wrench head 3 positioned at one end thereof having a first orifice 5 formed for engagement with various fasteners. First orifice 5 may be open ended or closed such as this box wrench type configuration. First orifice 5 has an across-width dimension 7 and a depth dimension 9 and an imaginary central axis of wrench rotation 11 seen best in FIG. 1. In preferred embodiments of the present invention, the across-width dimension 7 is generally greater than the depth dimension 9 so that wrench head 3 has a relatively thin structure for excellent accessibility to fasteners in tight spaces and limited-access environments. There is a first handle portion 13 connected to wrench head 3. First handle portion 13 may be fixedly connected to wrench head 3 as shown, or alternatively, first handle portion 13 may be pivotably connected to wrench head 3. First handle portion 13 is elongated in a predetermined longitudinal direction as shown in FIGS. 3, 4 and 5. First handle portion 13 also has a cross-sectional shape and a defined minimum cross-sectional thickness 15 when viewed in a cross-sectional plane perpendicular to the longitudinal direction as seen in FIG. 6. Applicant defines “cross-sectional” herein as relating to a cut section of a handle portion with the cut being substantially perpendicular to an imaginary longitudinal axis. Applicant defines “thickness” herein, as being the smallest dimension measurable across and through the center of a cut section of a handle portion. It is important that first handle portion 13 does not obstruct the accessibility and fastener engagement of wrench head 3, especially in tight spaces or limited-access environments. According, first handle portion 13 has a cross-sectional shape that is elongated in a direction 17 substantially perpendicular to the axis of wrench rotation 11 seen best in FIG. 6. And, there is a second handle portion 19 connected at the other end of wrench 1. Second handle portion 19 is also elongated in the same predetermined longitudinal direction as seen in FIGS. 3, 4 and 5. In some preferred embodiments, the second handle portion 19 is fixedly connected to wrench 1 as is the case with this one piece wrench shown here in FIGS. 1-6. Second handle portion 19 has a defined minimum cross-sectional thickness dimension 21 which is substantially greater than the defined minimum cross-sectional thickness dimension 15 of first handle portion 13 as shown in FIG. 3. Present invention wrench 1 is structured this way for the comfortable application of force by a user to turn wrench 1 around imaginary axis 11 of wrench head 3. In this preferred embodiment, second handle portion 19 is cylindrically shaped and has a distal end 23 with a second orifice 25 formed therein seen best in FIG. 2. The second orifice 25 is formed for engagement with various fasteners and has an imaginary axis of wrench rotation 27 which is substantially aligned with the aforementioned predetermined longitudinal direction. Second orifice 25 is usually the same size as first orifice 5, so that a user may perform both high torque and low torque operations to a particular size fastener using the same wrench. Accordingly, present invention driver wrench 1 is structured with a relatively large, comfortable and ergonomic handle portion 19 for the application of force by a user to break loose or finally tighten a fastener during high torque operations. In addition, present invention driver wrench 1 is also structured so that a fastener may be “driven” on or off quickly using a wrist operation similar to that used with a screwdriver while engaging orifice 25 during low torque operations. The present invention wrench configuration is especially practical in confined spaces and limited-access environments. In some preferred embodiments of the present invention driver wrench, the second handle portion 19 has a predetermined total length dimension 27 that is generally equal to or greater than ⅓ the total length dimension 29 of wrench 1, so as to provide a preferred dimensional relationship between the second handle portion 19 and the entire wrench 1.

FIG. 7 shows a cross-sectional view of another embodiment of a present invention driver wrench, wherein present invention driver wrench 41 comprises two principle handle portions including a first handle portion 45 fixedly connected to a second handle portion 49 using a fastener type means. Applicant contemplates the possibility of a tool manufacturer utilizing an existing deep socket (normally used with a ratchet type wrench) as the second handle portion 49, then joining it to a separately fabricated first handle portion 45 using a machine screw 51 and washer 53 as shown. Obviously, the fastener means shown in this FIG. 7 represents only one of many possible fastener means which could be utilized by one skilled in the art to effectively join the two proposed wrench handle portions. Alternatively, the two handle portions could be welded together using a resistance welding method or welding a bead at seam 55. First handle portion 45 may have a wrench head 43 integrally attached as shown or pivotably attached with a pivoting axle (not shown.) Accordingly, present invention driver wrench 41 is structured with a relatively large, comfortable and ergonomic handle portion 49 for the application of force by a user to break loose or finally tighten a fastener using wrench head 43 during high torque operations. In addition, present invention driver wrench 41 is also structured so that a fastener may be “driven” on or off quickly using a wrist operation similar to that used with a screwdriver when engaging orifice 47 during low torque operations. Such a configuration is especially practical in confined spaces and limited-access environments.

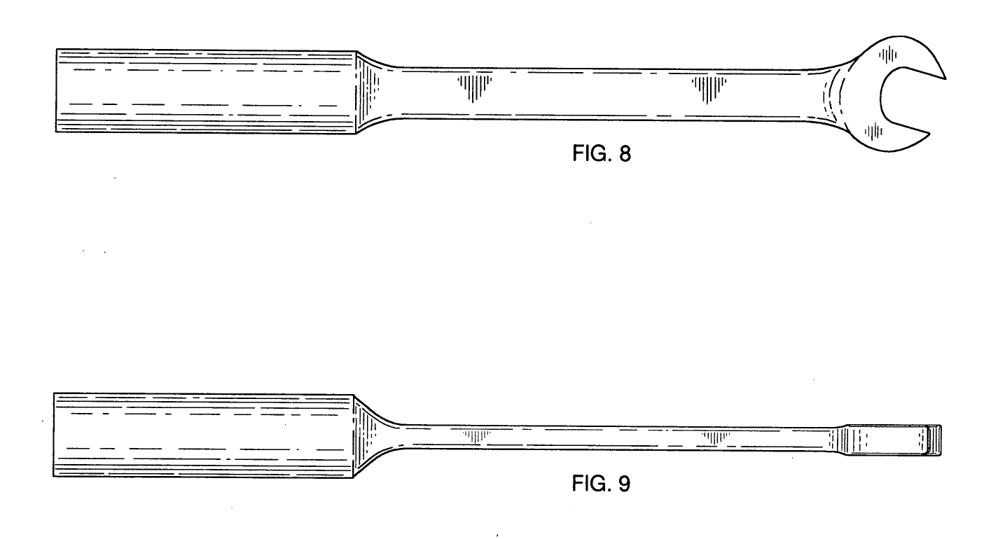

FIG. 8 shows a top plan view of another embodiment of a present invention driver wrench, wherein the wrench head is an open-end type as shown.

FIG. 9 shows a left side elevation view of the present invention driver wrench shown in FIG. 8.

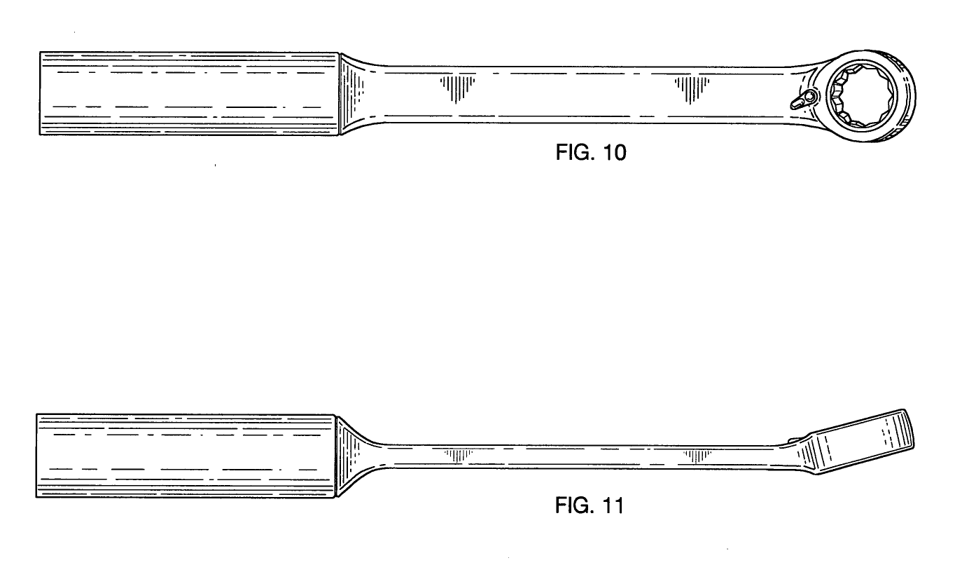

FIG. 10 shows a top plan view of another embodiment of a present invention driver wrench, wherein wrench head is a box type configuration with a ratcheting mechanism.

FIG. 11 shows a left side elevation view of the present invention driver wrench shown in FIG. 10.

Upon reading and understanding the specification of the present invention described above, modifications and alterations will become apparent to those skilled in the art. It is intended that all such modifications and alterations be included insofar as they come within the scope of the patent as claimed or the equivalence thereof.

1. A double-ended wrench comprising:
a wrench head positioned at one end thereof having a first orifice formed for engagement with various fasteners, said first orifice having an across-width dimension and a depth dimension and an imaginary central axis of wrench rotation, said across-width dimension generally being greater than said depth dimension; and,
a first handle portion connecting to said wrench head, said first handle portion being elongated in a predetermined longitudinal direction and having a cross-sectional shape and a defined minimum cross-sectional thickness when viewed in a cross-sectional plane perpendicular to said longitudinal direction, the cross-sectional shape of said first handle portion being elongated in a direction substantially perpendicular to the axis of wrench rotation of said first orifice; and,
a second handle portion fixedly connected at the other end of said wrench, and being elongated in said predetermined longitudinal direction, said second handle portion having a defined minimum cross-sectional thickness substantially greater than the defined minimum cross-sectional thickness of said first handle portion, said second handle portion further having a distal end with a second orifice formed therein, said second orifice formed for engagement with various fasteners and having an imaginary axis of wrench rotation being substantially aligned with said predetermined longitudinal direction.

2. A wrench of claim 1, wherein said wrench is formed as a one piece wrench.

3. A wrench of claim 1, wherein said second handle portion is fabricated as a separate component of said wrench.

4. A wrench of claim 1, wherein said wrench and said second handle portion each have a predetermined total length, and, the length of said second handle portion is generally equal to or greater than ⅓ the total length of said wrench.

5. A wrench of claim 1, wherein the second handle portion of said wrench is cylindrically formed.

6. A wrench of claim 2, wherein said wrench and said second handle portion each have a predetermined total length, and, the length of said second handle portion is generally equal to or greater than ⅓ the total length of said wrench.

7. A wrench of claim 2, wherein the second handle portion of said wrench is cylindrically formed.

8. A wrench of claim 3, wherein said wrench and said second handle portion each have a predetermined total length, and, the length of said second handle portion is generally equal to or greater than ⅓ the total length of said wrench.

9. A wrench of claim 3, wherein the second handle portion of said wrench is cylindrically formed.

10. A wrench of claim 3, wherein said second handle portion is fixedly connected to said wrench using a welding means.

11. A wrench of claim 3, wherein said second handle portion is fixedly connected to said wrench using fastener means.

12. A double-ended wrench comprising:
a wrench head positioned at one end thereof having a first orifice formed for engagement with various fasteners, said first orifice having an across-width dimension and a depth dimension and an imaginary central axis of wrench rotation, said across-width dimension generally being greater than said depth dimension; and,
a first handle portion connecting to said wrench head, said first handle portion being elongated in a predetermined longitudinal direction and having a cross-sectional shape and a defined minimum cross-sectional thickness when viewed in a cross-sectional plane perpendicular to said longitudinal direction, the cross-sectional shape of said first handle portion being elongated in a direction substantially perpendicular to the axis of wrench rotation of said first orifice; and,
a second handle portion positioned at the other of end of said wrench, and being elongated in said predetermined longitudinal direction, said second handle portion having a defined minimum cross-sectional thickness substantially greater than the defined minimum cross-sectional thickness of said first handle portion, said second handle portion further having a distal end with a second orifice formed therein, said second orifice formed for engagement with various fasteners and having an imaginary axis of wrench rotation being substantially aligned with said predetermined longitudinal direction, and further wherein, said wrench and said second handle portion each have a predetermined total length, and, the length of said second handle portion is generally equal to or greater than ⅓ the total length of said wrench.

13. A wrench of claim 12, wherein said wrench is formed as a one piece wrench.

14. A wrench of claim 12, wherein said second handle portion is fabricated as a separate component of said wrench.

15. A wrench of claim 12, wherein the second handle portion of said wrench is cylindrically formed.

16. A wrench of claim 12, wherein said second handle portion is pivotably connected to said wrench using a pivot means.

17. A wrench of claim 13, wherein the second handle portion of said wrench is cylindrically formed

18. A wrench of claim 14, wherein said second handle portion is fixedly connected to said wrench using a welding means.

19. A wrench of claim 14, wherein said second handle portion is fixedly connected to said wrench using fastener means.

20. A wrench of claim 14, wherein said second handle portion is pivotably connected to said wrench using a pivot means.
